(19) United States
(12) Patent Application Publication
(10) Pub. No.: US 2019/0333718 A1
(43) Pub. Date: Oct. 31, 2019

(54) PUSH SWITCH

(71) Applicant: ALPS ALPINE CO., LTD., Tokyo (JP)

(72) Inventors: Makoto HAYASHI, Miyagi (JP); Nobuyuki NINOMIYA, Miyagi (JP); Tatsuaki KAWASE, Miyagi (JP); Hisato SHIMOMURA, Miyagi (JP)

(21) Appl. No.: 16/504,704

(22) Filed: Jul. 8, 2019

Related U.S. Application Data
(63) Continuation of application No. PCT/JP2017/044376, filed on Dec. 11, 2017.

(30) Foreign Application Priority Data
Jan. 24, 2017 (JP) 2017-010730

(51) Int. Cl. H01H 3/12; H01H 13/14

(52) U.S. Cl. CPC H01H 3/122; H01H 2205/002; H01H 13/14

(57) ABSTRACT

A push switch includes a housing; a fixed contact member, including a fixed contact, placed inside the housing; a movable contact member, including a movable portion, placed inside the housing; a slider, which moves in a vertical direction, placed above the fixed contact member and the movable contact member; and an elastic member, having a restoring force in a direction in which the slider separates from the housing, placed between the housing and the slider. A movable member is placed between the housing and the slider and is in contact with a part of the slider and is movable as the slider moves. As the slider is pushed toward the housing, the movable member in contact with the slider moves, whereby the fixed contact and the movable portion are separated from each other, or the fixed contact and the movable portion are brought into contact with each other.

### CROSS-REFERENCE TO RELATED APPLICATION

The present application is a continuation application of International Application No. PCT/JP2017/044376 filed on Dec. 11, 2017, which is based on and claims priority to Japanese Patent Application No. 2017-010730 filed on Jan. 24, 2017. The contents of these applications are incorporated herein by reference in their entirety.

### BACKGROUND OF THE INVENTION

### 1. Field of the Invention

The present invention relates to a push switch.

### 2. Description of the Related Art

As an input device of an information device, etc., a keyboard with which information can be input, etc., by pushing a keytop, is used. As such a keyboard, there is a keyboard in which a push switch is used. Such a push switch includes, for example, a keytop, a plunger body portion, a movable contact, a fixed contact, and the like (e.g., Patent Document 1). The plunger body portion is provided beneath the keytop, and in a state where the keytop or the like is not pushed, a cam portion of the plunger body portion and a movable contact of a movable contact plate are in contact with each other, and in the movable contact plate, a restoring force is generated in the direction of pushing the movable contact toward the side of the fixed contact. When the keytop or the like of such a push switch is pushed downward, the plunger body portion moves downward by being pushed by the keytop or the like, and accordingly, the cam portion of the plunger body portion that has been in contact with the movable contact, also moves downward, such that the movable contact plate turns into a movable state. As a result, by the restoring force of the movable contact plate, the movable contact moves and contacts the fixed contact, such that the switch is turned on. When the force pushing the keytop is not applied any longer, by the restoring force of the spring or the like, the keytop rises up and returns to the original state.
[Patent Document 1] Japanese Laid-open Patent Publication No. 2015-173085
[Patent Document 2] Japanese Laid-open Patent Publication No. 2006-19131

### SUMMARY OF THE INVENTION

According to one aspect of the present invention, there is provided a push switch including a housing; a fixed contact member including a fixed contact, the fixed contact member being placed inside the housing; a movable contact member including a movable portion, the movable contact member being placed inside the housing; a slider that moves in a vertical direction with respect to the housing, the slider being placed above the fixed contact member and the movable contact member; and an elastic member having a restoring force in a direction in which the slider separates from the housing, the elastic member being placed between the housing and the slider, wherein a movable member is placed between the housing and the slider, the movable member being in contact with a part of the slider, the movable member being movable as the slider moves, and as the slider is pushed toward the housing, the movable member that is in contact with the slider moves, whereby the fixed contact and the movable portion are separated from each other from a state of being in contact with each other, or the fixed contact and the movable portion are brought into contact with each other from a state of being separated from each other.

### BRIEF DESCRIPTION OF THE DRAWINGS

FIG. 1 is an exploded perspective view of a push switch according to a first embodiment;

FIG. 2 is an external perspective view of the top surface of the push switch (off state) according to the first embodiment;

FIG. 3 is an external perspective view of the top surface of the push switch (on state) according to the first embodiment;

FIG. 4 is a first perspective view of a slider of the push switch according to the first embodiment;

FIG. 5 is a second perspective view of a slider of the push switch according to the first embodiment;

FIG. 6 is a first perspective view of a movable member of the push switch;

FIG. 7 is a second perspective view of a movable member of the push switch;

FIG. 8 is a perspective view of a fixed contact member of the push switch;

FIG. 9 is a perspective view of a movable contact member of the push switch;

FIG. 10 is a perspective view of a housing of the push switch according to the first embodiment;

FIG. 11 is a first diagram illustrating an internal structure of the push switch according to the first embodiment;

FIG. 12 is a second diagram illustrating an internal structure of the push switch according to the first embodiment;

FIG. 13 is an external perspective view of the bottom surface of the push switch according to the first embodiment;

FIG. 14 is a first cross-sectional view of the push switch (off state) according to the first embodiment;

FIG. 15 is a second cross-sectional view of the push switch (off state) according to the first embodiment;

FIG. 16 is a first diagram illustrating the off state of the push switch according to the first embodiment;

FIG. 17 is a second diagram illustrating the off state of the push switch according to the first embodiment;

FIG. 18 is a first diagram illustrating the on state of the push switch according to the first embodiment;

FIG. 19 is a second diagram illustrating the on state of the push switch according to the first embodiment;

FIG. 20 is an illustrative view of the push switch according to the first embodiment having a light emitting element;

FIG. 21 is an exploded perspective view of the push switch according to a second embodiment;

FIG. 22 is an external perspective view of the top surface of the push switch (off state) according to the second embodiment;

FIG. 23 is a first perspective view of a slider of the push switch according to the second embodiment;

FIG. 24 is a second perspective view of a slider of the push switch according to the second embodiment;

FIG. 25 is a perspective view of a housing of the push switch according to the second embodiment;

FIG. 26 is a first perspective view of a link mechanism portion of the push switch according to the second embodiment;

FIG. 27 is a second perspective view of a link mechanism portion of the push switch according to the second embodiment;

FIG. 28 is a first explanation diagram of the push switch according to the second embodiment;

FIG. 29 is a second explanation diagram of the push switch according to the second embodiment; and

FIG. 30 is a third explanation diagram of the push switch according to the second embodiment.

### DETAILED DESCRIPTION OF THE PREFERRED EMBODIMENTS

In the push switch of the related art as described above in the Description of the Related Art, the movable contact and the fixed contact are formed of a metal material, and the plunger portion, etc., is formed of a resin material. In a state where the keytop or the like is not pushed, in the movable contact plate, a restoring force is generated in the direction of pushing the movable contact toward the cam portion of the plunger body portion. For this reason, by pushing a keytop or the like, the cam portion of the plunger body portion, formed of a resin material or the like that is relatively soft, moves downward while being in contact with the movable contact formed of metal that is relatively hard. The cam portion moves downward while being pushed by the restoring force of the movable contact plate, and, therefore, when the keytop or the like is pushed a number of times, the cam portion of the plunger body portion is scraped by the movable contact and wears down, which causes a change in the operational feeling when pushing the keytop or the like such that the user pushing the keytop or the like may sense a feeling of strangeness. In addition, when the frequency of pushing the keytop or the like is extremely high, the cam portion of the plunger body portion may wear down significantly, and the function as a switch may be lost. Particularly for switches used in game devices or the like, the push switch is pushed extremely frequently, and the user who is using the push switch is also sensitive to changes in the operational feeling of pushing the keytop or the like.

The push switch according to an aspect of the present invention does not change in the operational feeling.

An embodiment is described below. With respect to the same members, etc., explanations will be omitted upon applying the same reference numeral. In the present application, the directions in the X1-X2 direction, the Y1-Y2 direction, and the Z1-Z2 direction are orthogonal to each other. In addition, a plane including the X1-X2 direction and the Y1-Y2 direction is described as an XY plane, a plane including the Y1-Y2 direction and the Z1-Z2 direction is described as a YZ plane, and a plane including the Z1-Z2 direction and the X1-X2 direction is described as a ZX plane.

### [First Embodiment]

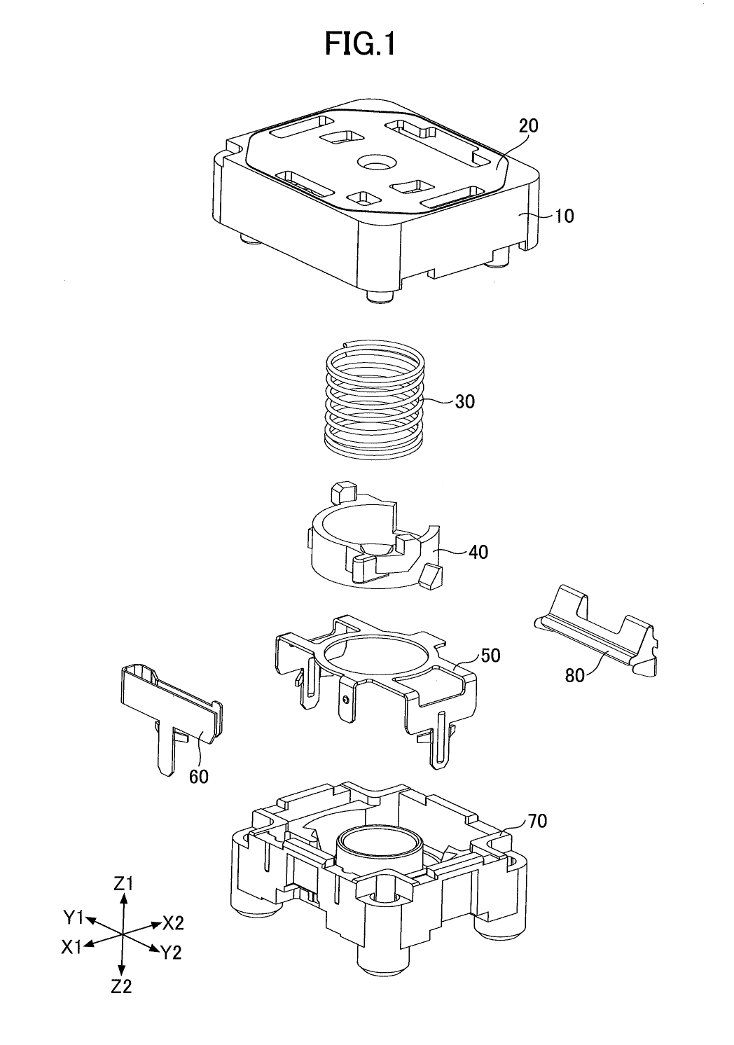

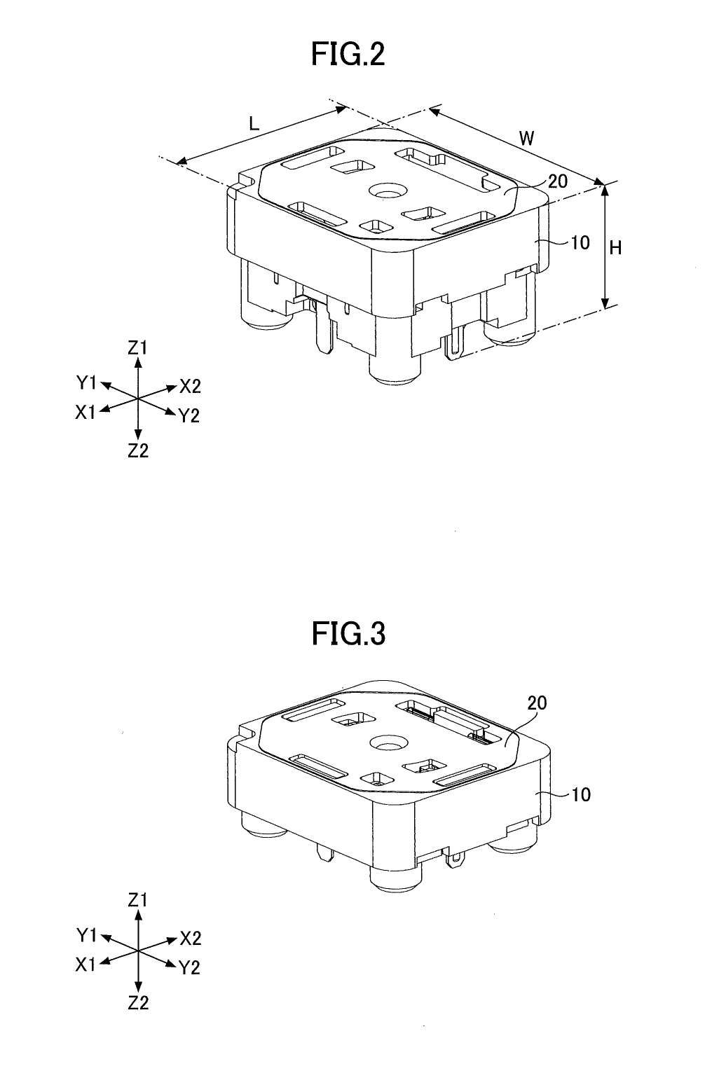

A push switch in a first embodiment includes a slider 10, a coil spring 30, a movable member 40, a fixed contact member 50, a movable contact member 60, a housing 70, a plate spring 80, and the like, as illustrated in FIGS. 1 to 3. FIG. 1 is an exploded perspective view of the push switch according to the present embodiment. FIG. 2 is a perspective view illustrating a state in which the push switch according to the present embodiment is not pushed, and FIG. 3 is a perspective view illustrating a state in which the push switch according to the present embodiment is pushed. As illustrated in FIG. 2, the push switch is formed such that the length L is approximately 10.65 mm, the width W is approximately 12.5 mm, and the height H is approximately 7.2 mm when the push switch is not pushed.

The slider 10 is formed of a transparent or translucent resin material such as POM (polyacetal). The slider 10 is formed so that the shape seen from the top is substantially rectangular, and because the slider 10 is pushed from the top surface, the top surface is substantially flat and parallel to the XY plane, and the top surface of the slider 10 is covered with a transparent or translucent sheet 20.

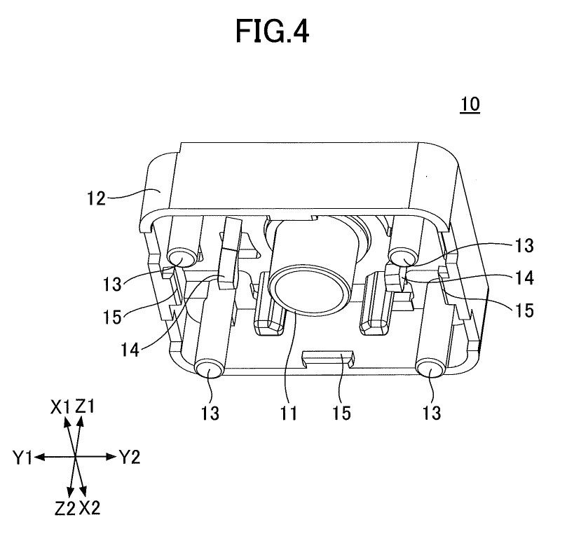

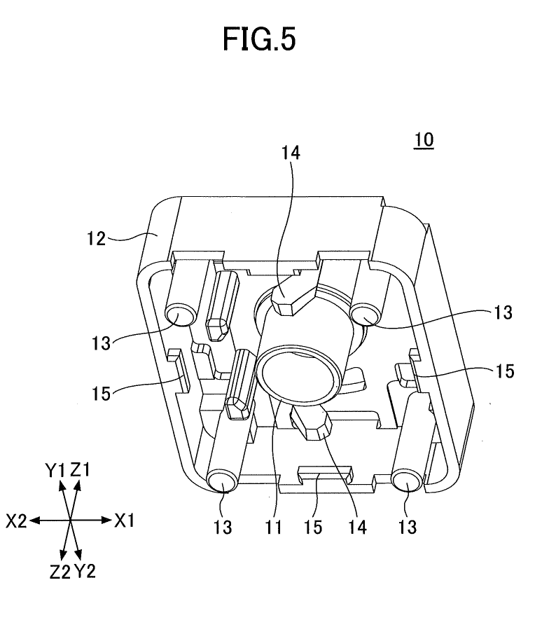

As illustrated in FIGS. 4 and 5, the inner bottom surface of the slider 10 is provided with a cylindrical cylinder portion 11 extending in the Z2 direction in the center part of the slider 10, and a cylindrical guide portion 13 extending in the Z2 direction provided near each of the four corners, and these elements are surrounded by a wall portion 12 extending in the Z2 direction. On the bottom side of the slider 10, two first cam portions 14 are provided. The two first cam portions 14 are positioned facing each other so that the cylinder portion 11 is interposed between the two first cam portions 14. Inside the wall portion 12 of the slider 10, there is provided a hook 15 for connecting to the housing 70 so that the slider 10 does not separate from the housing 70.

The coil spring 30 is formed of stainless steel or the like and is inserted between the slider 10 and the housing 70. The coil spring 30 has the function of returning the pushed slider 10 to the original state of the slider 10, and the coil spring 30 may be herein referred to as an elastic member.

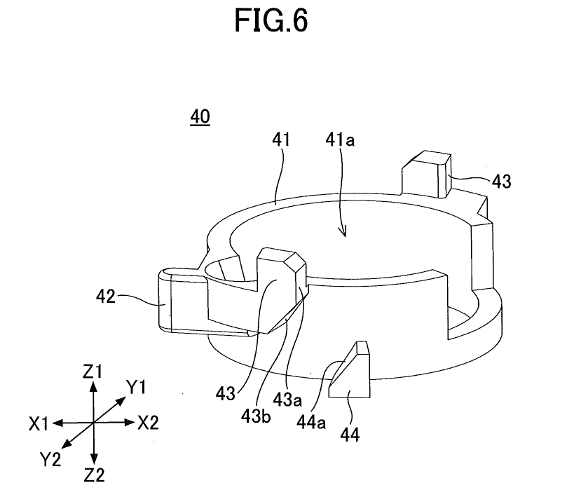

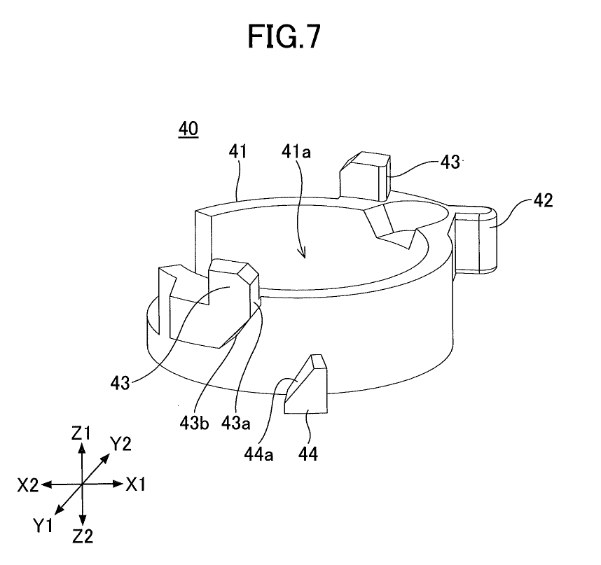

The movable member 40 is formed of a resin material such as POM. As illustrated in FIGS. 6 and 7, the movable member 40 is provided with a cylinder portion 41 in which an opening portion 41a is formed in the center part of the movable member 40, and around the cylinder portion 41, there are formed a protruding portion 42 protruding outward, and two second cam portions 43 provided on the Z1 side and two third cam portions 44 provided on the Z2 side on the outer side of the cylinder portion 41. The two second cam portions 43 and the two third cam portions 44 are provided corresponding to the two first cam portions 14 provided on the slider 10, and the two second cam portions 43 are respectively formed around the cylinder portion 41 on opposite sides at positions 180° to each other, and the two third cam portions 44 are respectively formed around the cylinder portion 41 on opposite sides at positions 180° to each other. A vertical surface 43a parallel to the Z1-Z2 direction and an inclined surface 43b inclined to the Z2 side are formed in the second cam portions 43, and an inclined surface 44a inclined to the Z1 side is formed in the third cam portions 44.

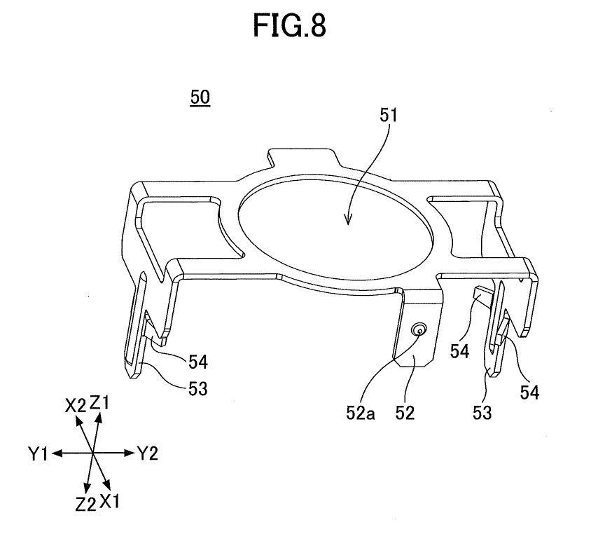

The fixed contact member 50 is formed of a conductive metallic material such as brass, and as illustrated in FIG. 8, an opening portion 51 is formed in the center part of the fixed contact member 50, and around the opening portion 51, a fixed contact portion 52 bent in the Z2 direction and two fixed contact terminals 53 are provided. A fixed contact 52a is formed in the fixed contact portion 52. In the vicinity of each of the fixed contact terminals 53, bending portions 54 are provided on both sides of the fixed contact terminal 53 to fix the fixed contact member 50 to the housing 70.

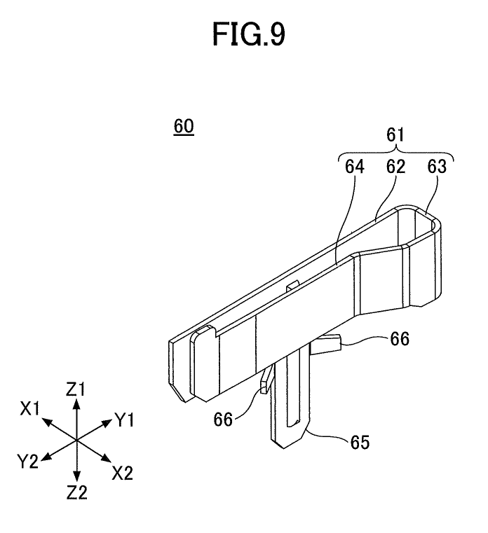

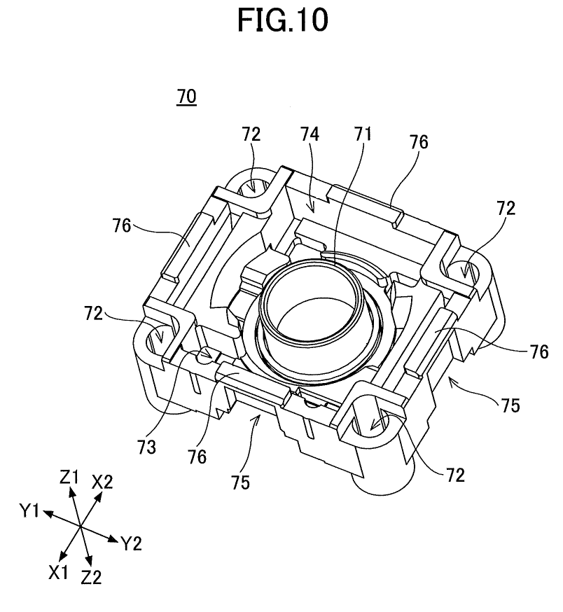

The movable contact member 60 is formed of phosphor bronze or the like, and the surface of the movable contact member 60 is gold plated. As illustrated in FIG. 9, the movable contact member 60 includes a movable spring portion 61 having a longitudinal direction in the Y1-Y2 direction and a movable contact terminal 65. The movable spring portion 61 is bent in a U-shape and is formed by a support portion 62, a bending portion 63, and a movable portion 64. The movable contact terminal 65 is formed to extend from the support portion 62 of the movable spring portion 61 in a Z2 direction. In the vicinity of the movable contact terminal 65, bending portions 66 are provided on both sides of the movable contact terminal 65 to fix the movable contact member 60 to the housing 70.

The housing 70 is provided with a cylindrical cylinder portion 71 extending in the Z1 direction in the inner center part of the housing 70 as illustrated in FIG. 10, and an opening hole 72, in which the guide portion 13 of the slider 10 enters, is provided at each of the four corners of the housing 70. Around the cylinder portion 71, there is provided a movable contact member mounting region 73 in which the movable contact member 60 is mounted, and a plate spring mounting region 74 in which the plate spring 80 is mounted. The four walls on the outside of the housing 70 are provided with recessed portions 75, and the Z1-direction ends of the recessed portions 75 are each provided with a catch portion 76.

The plate spring 80 is provided for generating a click sound when the slider 10 is pushed down.

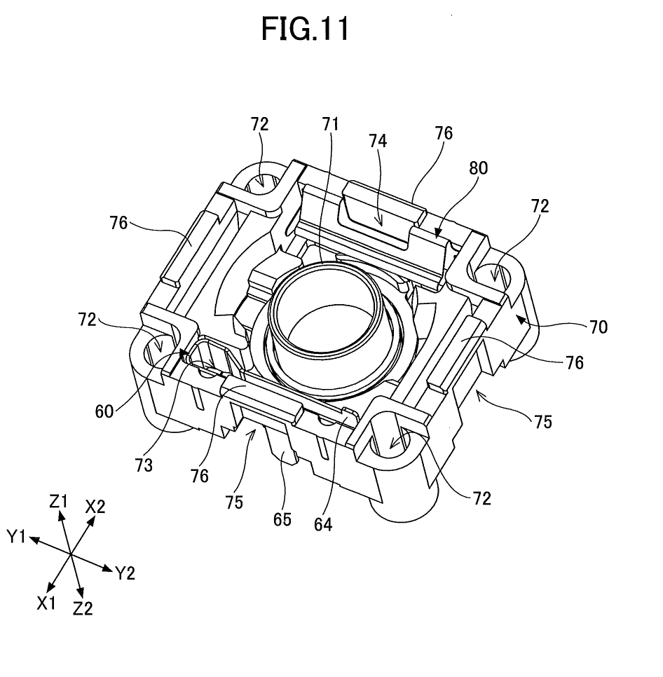

In the push switch in the present embodiment, as illustrated in FIG. 11, the movable contact member 60 is inserted inside the movable contact member mounting region 73 and the plate spring 80 is inserted inside the plate spring mounting region 74, on the inside of the housing 70. The movable contact member mounting region 73 is set so that the movable portion 64 is on the side of the cylinder portion 71 of the housing 70 and the movable contact terminal 65 is outside the housing 70.

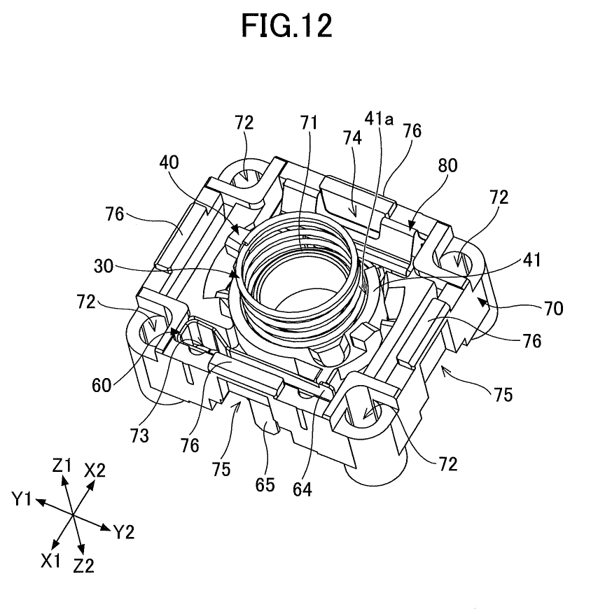

Also, as illustrated in FIG. 12, the coil spring 30 and the movable member 40 are mounted on the housing 70. In this state, the cylinder portion 71 of the housing 70 is inside the wound coil spring 30, and the coil spring 30 and the cylinder portion 71 of the housing 70 are inside the opening portion 41a of the movable member 40.

Also, although not illustrated, the fixed contact member 50 is mounted on the movable member 40, and furthermore, the slider 10 is mounted over both. In this state, the coil spring 30 is inside the opening portion 51 of the fixed contact member 50.

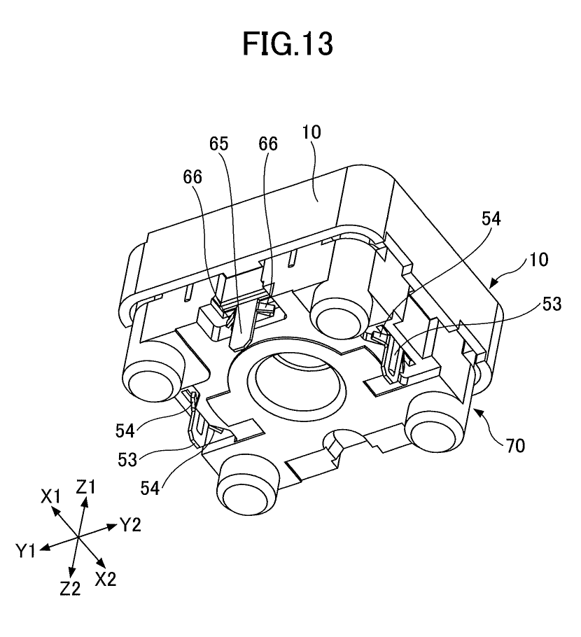

As illustrated in FIG. 13, in the push switch in the present embodiment, the two fixed contact terminals 53 provided in the fixed contact member 50 and the bending portions 54 provided near each of the fixed contact terminals 53 extend outside of the housing 70, and by bending the bending portions 54, the fixed contact member 50 is fixed to the housing 70. Similarly, the movable contact terminal 65 provided in the movable contact member 60 and the bending portions 66 provided near the movable contact terminal 65 extend outside of the housing 70, and by bending the bending portions 66, the movable contact member 60 is fixed to the housing 70.

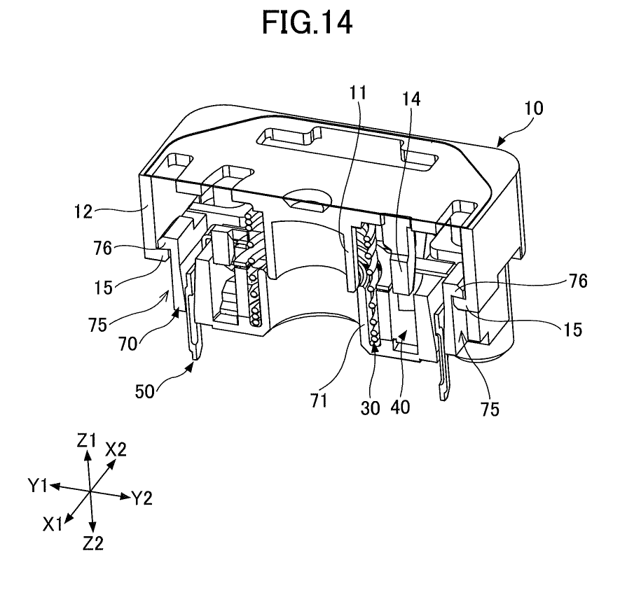

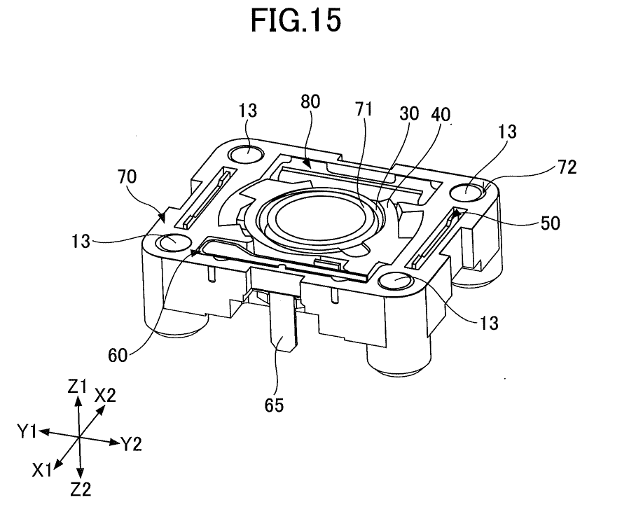

FIG. 14 is a cross-sectional view in which the push switch according to the present embodiment is cut in a YZ plane, and FIG. 15 is a cross-sectional view in which the push switch is cut in an XY plane. As illustrated in FIGS. 14 and 15, in the slider 10, a portion of the cylinder portion 11 of the slider 10 is inside the cylinder portion 71 of the housing 70, and a portion of each guide portion 13 provided in the slider 10 is inside the opening hole 72 of the housing 70. In addition, in a state where the slider 10 is not pushed down, the hook 15 of the slider 10 is hooked to the catch portion 76 of the housing 70, and in a state where the slider 10 is pushed down, the slider 10 moves downward, and accordingly, the hook 15 moves along the recessed portion 75 on the outer wall surface of the housing 70. When there is no more force pushing the slider 10, the restoring force of the coil spring 30 causes the slider 10 to move upward and back to its original state. However, the upper end of the recessed portion 75 of the housing 70 is provided with the catch portion 76, and the hook 15 of the slider 10 is caught by the catch portion 76 of the housing 70, and, therefore, the slider 10 does not detach from the housing 70.

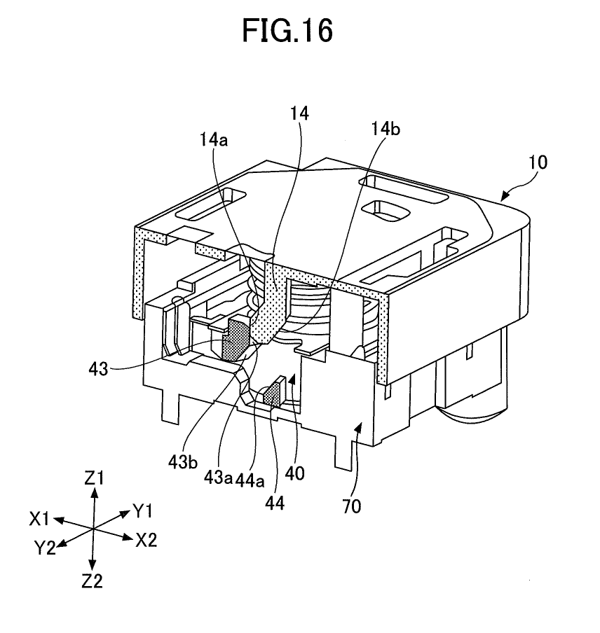

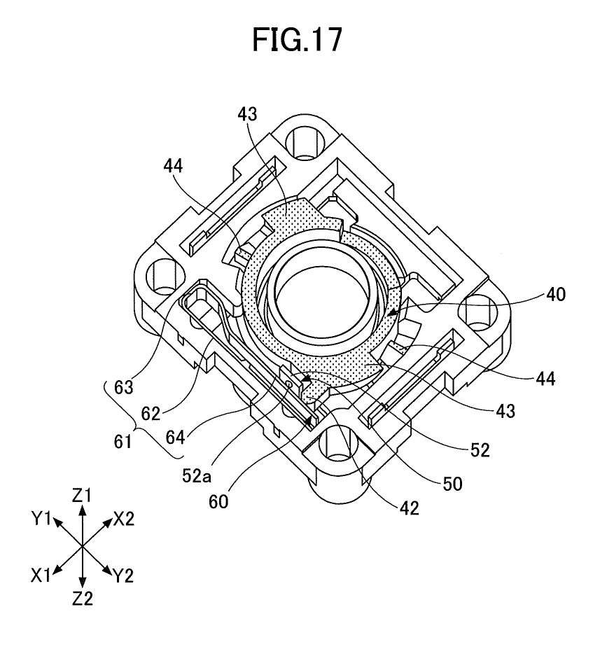

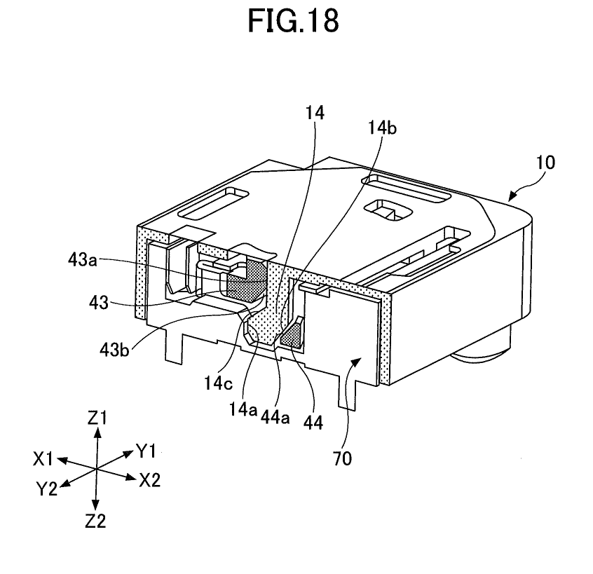

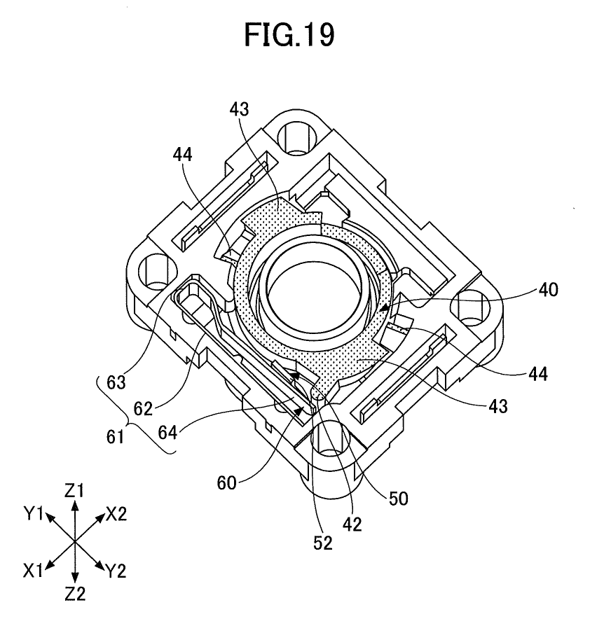

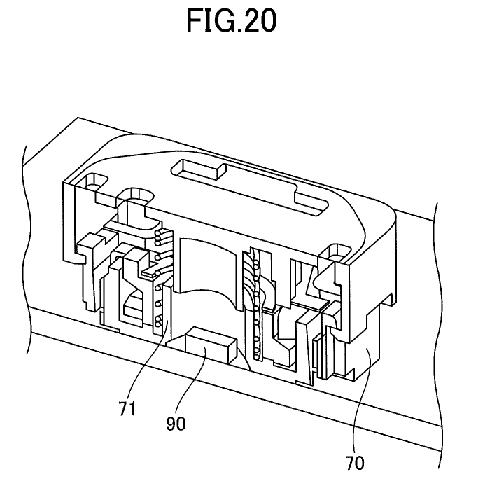

Next, the mechanism and operation of the push switch according to the present embodiment will be described. FIG. 16 is a cross-sectional view of the push switch of the present embodiment cut in a ZX plane in a state before the slider 10 is pushed down, and FIG. 17 is a cross-sectional view of the push switch cut in an XY plane in a state before the slider 10 is pushed down. FIG. 18 is a cross-sectional view of the push switch of the present embodiment cut in a ZX plane in a state where the slider 10 is pushed down, and FIG. 19 is a cross-sectional view cut in an XY plane in a state where the slider 10 is pushed down.

Before the slider 10 of the push switch in the present embodiment is pushed down, as illustrated in FIG. 17, the movable portion 64 of the movable contact member 60 mounted on the housing 70 is pushed by the protruding portion 42 of the movable member 40, and the movable portion 64 of the movable contact member 60 and the fixed contact 52a of the fixed contact portion 52 of the fixed contact member 50 are separated from each other, and, therefore, the switch is turned off. In this state, the movable contact member 60 is provided with a restoring force in a direction in which the movable portion 64 is directed toward the fixed contact portion 52, such that a vertical surface 14a of the first cam portion 14 of the slider 10 and the vertical surface 43a of the second cam portion 43 of the movable member 40 are in contact with each other. That is, due to the restoring force of the movable contact member 60, the protruding portion 42 of the movable member 40 is pushed, and a force is exerted on the movable member 40 to move to the right side in FIG. 16 and counterclockwise in FIG. 17, but the vertical surface 14a of the first cam portion 14 of the slider 10 and the vertical surface 43a of the second cam portion 43 of the movable member 40 are in contact with each other, and, therefore, the movable member 40 is in a state of being unable to move to the right side in FIG. 16 or counterclockwise in FIG. 17.

Next, when pushing down the slider 10 of the push switch of the present embodiment, the slider 10 moves in the Z2 direction, which is downward, as illustrated in FIG. 18. Accordingly, the first cam portion 14 provided in the slider 10 also moves downward, and the vertical surface 14a of the first cam portion 14 of the slider 10 moves below the vertical surface 43a of the second cam portion 43 of the movable member 40, as illustrated in FIG. 18. Accordingly, the protruding portion 42 of the movable member 40 is pushed by the restoring force of the movable contact member 60, and the movable member 40 moves to the right side in FIG. 18 and counterclockwise in FIG. 19. That is, due to the restoring force of the movable contact member 60, the protruding portion 42 of the movable member 40 rotates in a direction away from the fixed contact portion 52 of the fixed contact member 50, and the movable portion 64 of the movable contact member 60 and the fixed contact 52a of the fixed contact portion 52 of the fixed contact member 50 contact each other, and, therefore, the switch is turned on. At this time, the coil spring 30 is compressed, and, therefore, the restoring force is increased. In the present embodiment, the movable member 40 rotates on an axis corresponding to the Z1-Z2 direction in which the slider 10 is pushed. Accordingly, the direction of rotation of the movable member 40 is in a plane parallel to the XY plane and orthogonal to the Z1-Z2 direction in which the slider 10 is pushed.

Also, when the movable member 40 cannot be sufficiently moved by the restoring force of the movable contact member 60 alone, an inclined surface 14b provided in the first cam portion 14 of the slider 10 contacts the inclined surface 44a of the third cam portion 44 of the movable member 40, to push the third cam portion 44. Accordingly, the movable member 40 moves to the right side in FIG. 18 and counterclockwise in FIG. 19.

When the force pushing the slider 10 is not applied any longer, the restoring force of the coil spring 30 causes the slider 10 to rise. Thus, an inclined surface 14c of the first cam portion 14 of the slider 10 and the inclined surface 43b of the second cam portion 43 of the movable member 40 contact each other, and a restoring force of the coil spring 30 causes the slider 10 to move upward, and, therefore, the movable member 40 moves to the left side in FIG. 18 and clockwise in FIG. 19. Thus, the movable portion 64 of the movable contact member 60 is pushed by the protruding portion 42 of the movable member 40, and the movable portion 64 of the movable contact member 60 and the fixed contact 52a of the fixed contact portion 52 of the fixed contact member 50 are separated from each other, and the switch is turned off.

In the present embodiment, the on/off state of the switch is switched depending on whether the protruding portion 42 of the movable member 40 formed of a resin material is pushing the movable portion 64 of the movable contact member 60 formed of metal. For this reason, the protruding portion 42 of the movable member 40 formed of a resin material will not be scraped and worn down. Accordingly, the operational feeling of pushing the slider 10 will not change, and the user who operates the keytop will not sense a feeling of strangeness.

Further, in the present embodiment, the first cam portion 14 of the slider 10 and the second cam portion 43 of the movable member 40 move in contact with each other, but both are formed of a relatively soft resin material, and, therefore, neither is appreciably scraped or worn down. Accordingly, the user who operates the keytop will not sense a feeling of strangeness, and the reliability is high.

In the present embodiment, as illustrated in FIG. 20, the housing 70 is formed so that a light emitting element 90 can be installed inside, and the light emitting element 90, such as an LED, can be installed in the space inside the cylinder portion 71 in the housing 70. In this way, by installing the light emitting element 90 such as an LED in the space inside the cylinder portion 71, the light can be transmitted through the slider 10 formed of a transparent or translucent material, and the upper surface side of the push switch can be illuminated.

In the present embodiment, the movable member 40 is described to make a rotating motion centered on the cylinder portion 71 of the housing 70; however, the movable member 40 may make a sliding motion.

### [Second Embodiment]

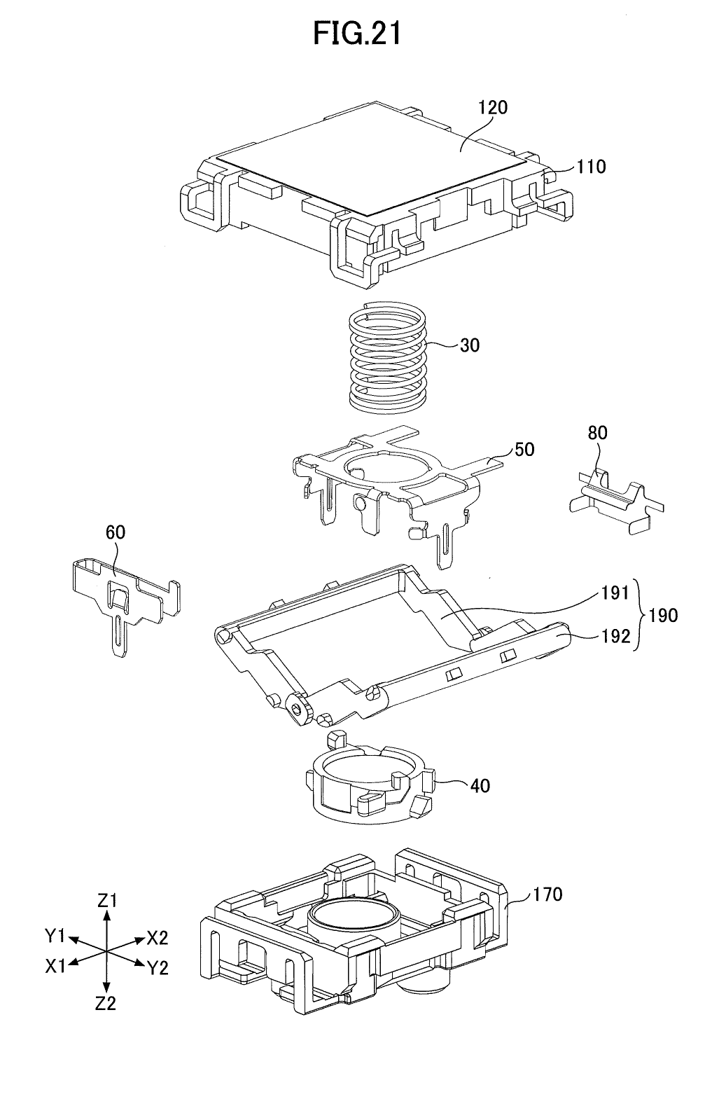

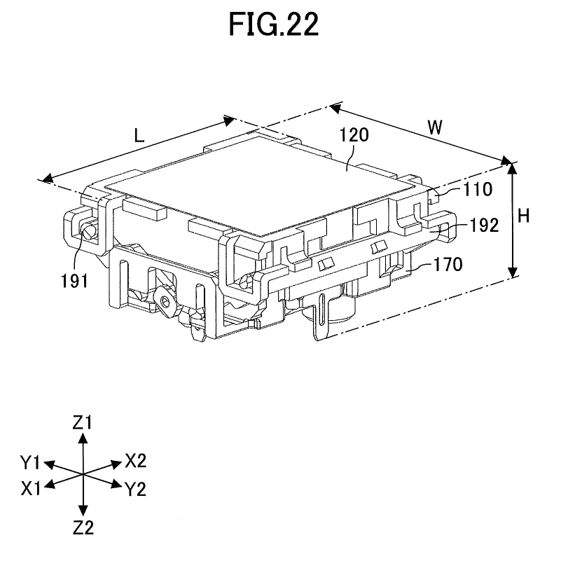

The push switch in the second embodiment includes a slider 110, the coil spring 30, the movable member 40, the fixed contact member 50, the movable contact member 60, a housing 170, the plate spring 80, a link mechanism portion 190, and the like, as illustrated in FIGS. 21 and 22. FIG. 21 is an exploded perspective view of the push switch according to the present embodiment. FIG. 22 is a perspective view illustrating a state in which the push switch according to the present embodiment is not pushed. As illustrated in FIG. 22, the push switch is formed such that the length L is approximately 12.65 mm, the width W is approximately 12.6 mm, and the height H is approximately 6.4 mm when the push switch is not pushed.

The slider 110 is formed of a transparent or translucent resin material, such as POM. The slider 110 is formed so that the shape seen from the top is substantially rectangular, and the slider 110 is pushed from the top surface, and, therefore, the top surface is substantially flat and parallel to the XY plane, and the top surface of the slider 110 is covered with a transparent or translucent sheet 120.

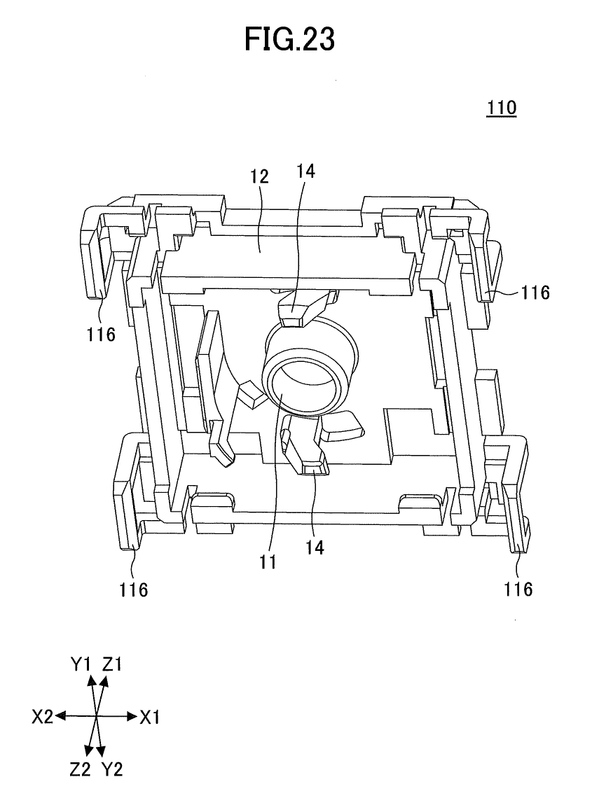

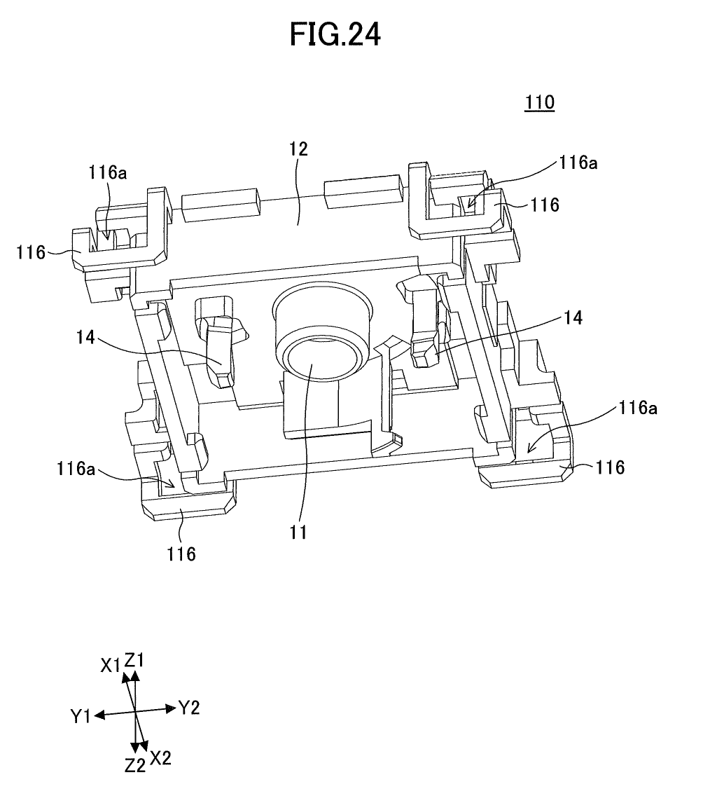

As illustrated in FIGS. 23 and 24, the bottom surface inside the slider 110 is not provided with the guide portions 13, unlike the slider 10 in the first embodiment, but the slider 110 is provided with a link support portion 116 in each of the four corners. Specifically, on the Y1 side of the slider 110, the link support portions 116 are provided at the end of the X1 side and the end of the X2 side, and on the Y2 side of the slider 110, the link support portions 116 are provided at the end of the X1 side and the end of the X2 side. Each link support portion 116 is provided with a support hole 116a through which a portion of the link mechanism portion 190 enters. FIGS. 23 and 24 are perspective views of the slider 110 viewed from different directions.

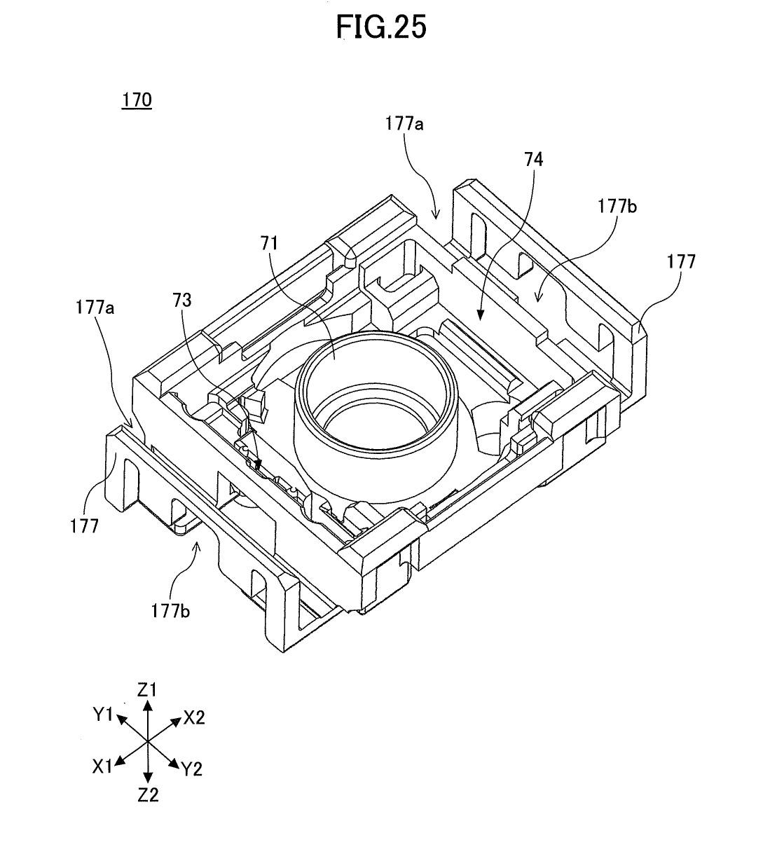

As illustrated in FIG. 25, unlike the housing 70 in the first embodiment, the housing 170 is not provided with the opening holes 72, but a link support portion 177 is provided at each of the end in the X1 direction and the end in the X2 direction. Each link support portion 177 is provided with a groove portion 177a and a support hole 177b in which a portion of the link mechanism portion 190 enters.

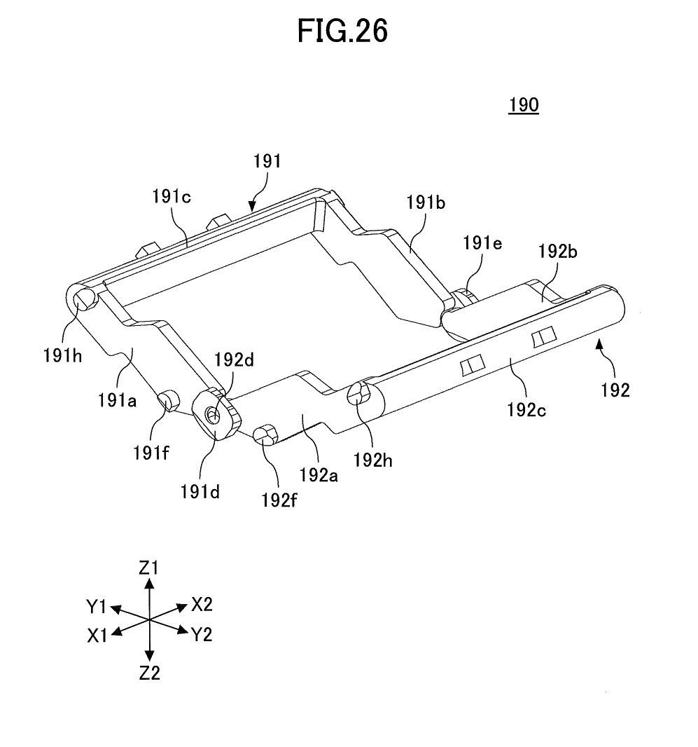

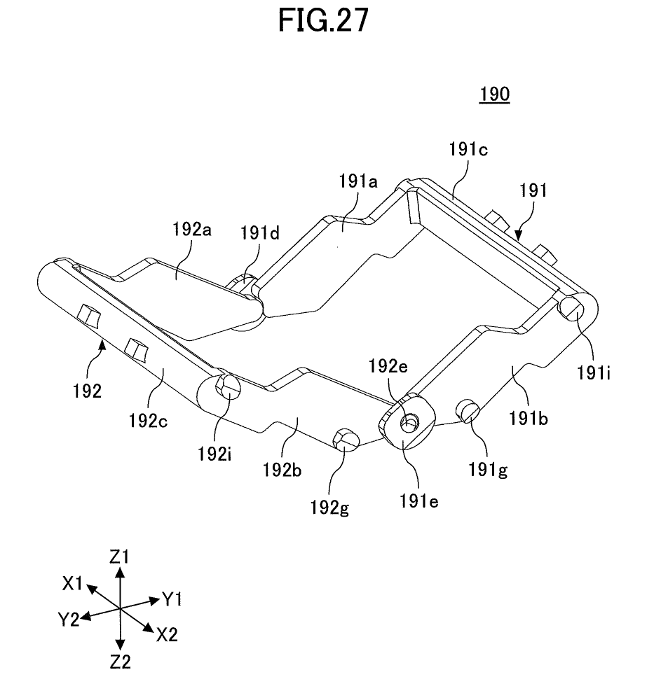

The link mechanism portion 190 is a pantograph mechanism formed by a first link portion 191 and a second link portion 192 as illustrated in FIGS. 26 and 27. FIGS. 26 and 27 are perspective views of the link mechanism portion 190 viewed from different directions.

The first link portion 191 is formed by two arm portions 191a and 191b and a connection portion 191c connecting one end portion of the arm portion 191a with one end portion of the arm portion 191b, thereby forming a U shape. Accordingly, the connection portion 191c is formed so as to extend in the X1-X2 direction, and the arm portion 191a that is substantially parallel to the YZ plane is formed at the end of the connection portion 191c on the X1 side, and the arm portion 191b that is substantially parallel to the YZ plane is formed at the end of the connection portion 191c on the X2 side. Thus, the arm portions 191a and 191b are substantially parallel.

The other end portion of the arm portion 191a is provided with a connection hole portion 191d, and a first protruding portion 191f and a second protruding portion 191h that protrude on the X1 side are provided on the surface of the arm portion 191a on the X1 side. The second protruding portion 191h is provided near one end portion of the arm portion 191a, and the first protruding portion 191f is provided closer to the connection hole portion 191d side than the midpoint between the connection hole portion 191d and the second protruding portion 191h.

A connection hole portion 191e is provided at the other end of the arm portion 191b, and a first protruding portion 191g and a second protruding portion 191i that protrude on the X2 side are provided on the surface of the arm portion 191b on the X2 side. The second protruding portion 191i is provided near one end of the arm portion 191b, and the first protruding portion 191g is provided closer to the connection hole portion 191e side than the midpoint between the connection hole portion 191e and the second protruding portion 191i.

The second link portion 192 is formed by two arm portions 192a and 192b, and a connection portion 192c connecting one end portion of the arm portion 192a with one end portion of the arm portion 192b, thereby forming a U shape. Accordingly, the connection portion 192c is formed so as to extend in the X1-X2 direction, and the arm portion 192a that is substantially parallel to the YZ surface is formed at the end of the connection portion 192c on the X1 side, and the arm portion 192b that is substantially parallel to the YZ surface is formed at the end of the connection portion 192c on the X2 side. Thus, the arm portion 192a and the arm portion 192b are substantially parallel.

The surface on the X1 side of the arm portion 192a is provided with a connection protruding portion 192d, a first protruding portion 192f, and a second protruding portion 192h that protrude on the X1 side. The connection protruding portion 192d is provided near the other end portion of the arm portion 192a, and the second protruding portion 192h is provided near one end portion of the arm portion 192a, and the first protruding portion 192f is provided closer to the connection protruding portion 192d side than the midpoint between the connection protruding portion 192d and the second protruding portion 192h.

The surface of the arm portion 192b on the X2 side is provided with a connection protruding portion 192e, a first protruding portion 192g, and a second protruding portion 192i that protrude on the X2 side. The connection protruding portion 192e is provided near the other end portion of the arm portion 192b, the second protruding portion 192i is provided near one end portion of the arm portion 192b, and the first protruding portion 192g is provided closer to the connection protruding portion 192e side than the midpoint between the connection protruding portion 192e and the second protruding portion 192i.

In the present embodiment, the connection protruding portion 192d of the arm portion 192a of the second link portion 192 is inside the hole of the connection hole portion 191d of the arm portion 191a of the first link portion 191, the connection protruding portion 192e of the arm portion 192b of the second link portion 192 is inside the hole of the connection hole portion 191e of the arm portion 191b of the first link portion 191, and the first link portion 191 and the second link portion 192 are connected in a rotatable state, thereby forming the link mechanism portion 190.

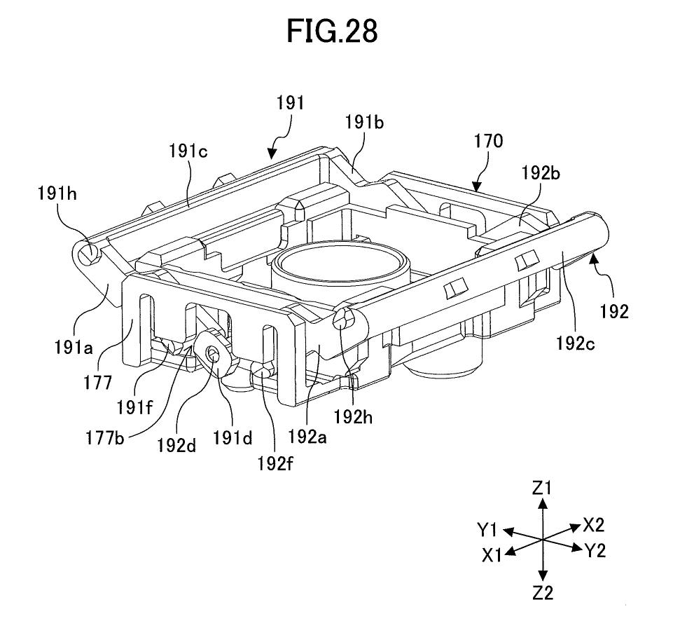

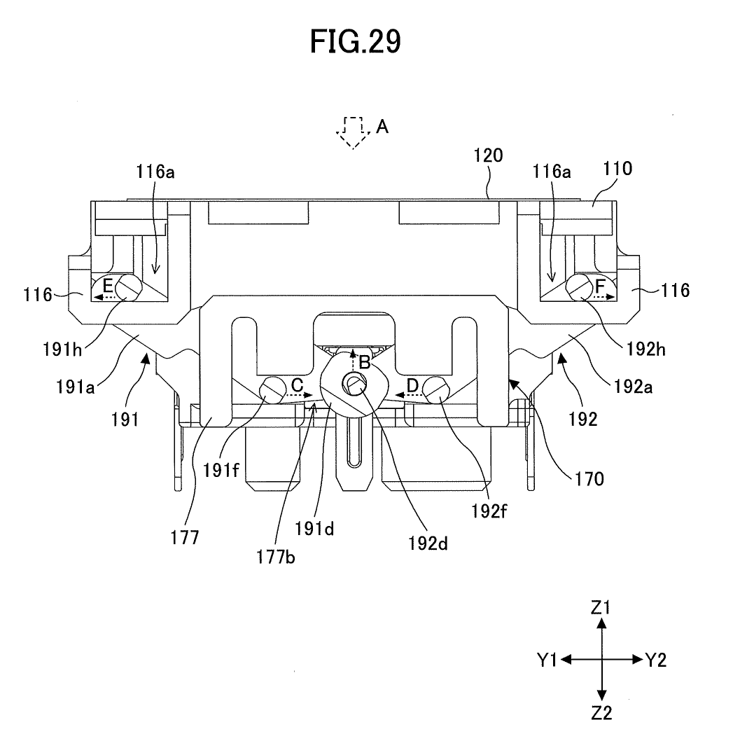

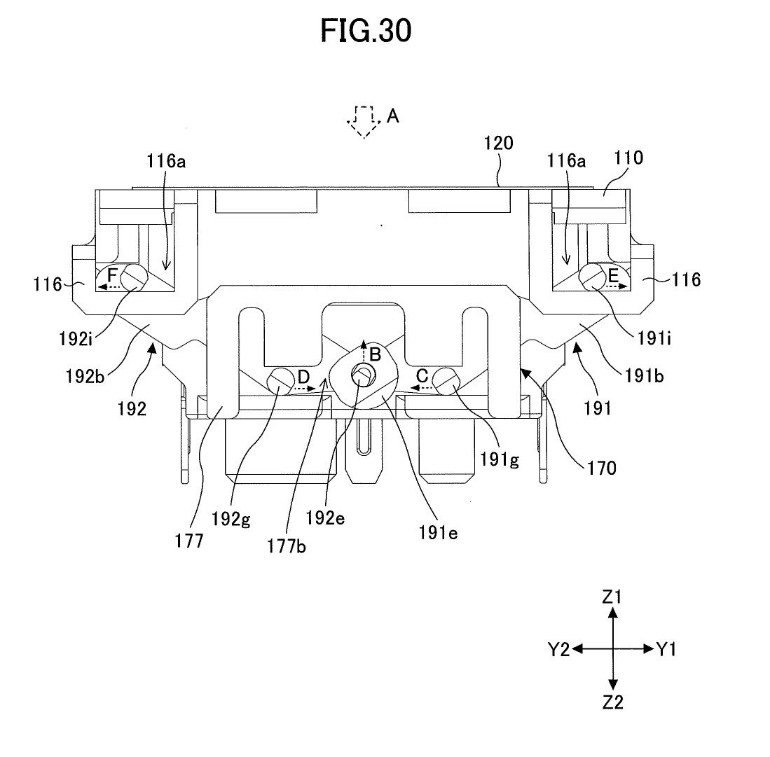

In the present embodiment, as illustrated in FIGS. 28 to 30, the slider 110 and the housing 170 are connected by the link mechanism portion 190 in which the first link portion 191 and the second link portion 192 are connected in a rotatable state. FIG. 28 illustrates a state in which the link mechanism portion 190 is inserted into the housing 170, FIG. 29 illustrates the push switch according to the present embodiment viewed from the X1 side, and FIG. 30 illustrates the push switch according to the present embodiment viewed from the X2 side.

Specifically, in the groove portion 177a of the link support portion 177 on the X1 side of the housing 170, a portion of the arm portion 191a of the first link portion 191 and the arm portion 192a of the second link portion 192 are inserted, and in the support hole 177b of the link support portion 177 on the X1 side, the connection hole portion 191d of the arm portion 191a of the first link portion 191, the connection protruding portion 192d of the arm portion 192a of the second link portion 192, the first protruding portion 191f of the arm portion 191a, and the first protruding portion 192f of the arm portion 192a, are inserted.

In the support hole 177b of the link support portion 177 on the X1 side, the connection hole portion 191d of the first link portion 191 and the connection protruding portion 192d of the second link portion 192 can move in the Z1-Z2 direction, and the first protruding portion 191f of the arm portion 191a and the first protruding portion 192f of the arm portion 192a can move in the Y1-Y2 direction.

Similarly, in the groove portion 177a of the link support portion 177 on the X2 side, a portion of the arm portion 191b of the first link portion 191 and the arm portion 192b of the second link portion 192 are inserted, and in the support hole 177b of the link support portion 177 on the X2 side, the connection hole portion 191e of the arm portion 191b of the first link portion 191, the connection protruding portion 192e of the arm portion 192b of the second link portion 192, the first protruding portion 191g of the arm portion 191b, and the first protruding portion 192g of the arm portion 192b are inserted.

In the support hole 177b of the link support portion 177 on the X2 side, the connection hole portion 191e of the first link portion 191 and the connection protruding portion 192e of the second link portion 192 can move in the Z1-Z2 direction, and the first protruding portion 191g of the arm portion 191a and the first protruding portion 192g of the arm portion 192a can move in the Y1-Y2 direction.

On the Y1 side of the slider 110, in the support hole 116a of the link support portion 116 provided at the end of the X1 side, the second protruding portion 191h of the first link portion 191 is inserted, and in the support hole 116a of the link support portion 116 provided at the end of the X2 side, the second protruding portion 191i of the first link portion 191 is inserted. On the Y2 side of the slider 110, in the support hole 116a of the link support portion 116 provided at the end of the X1 side, the second protruding portion 192h of the second link portion 192 is inserted, and in the support hole 116a of the link support portion 116 provided at the end of the X2 side, the second protruding portion 192i of the second link portion 192 is inserted.

The second protruding portion 191h, the second protruding portion 191i, the second protruding portion 192h, and the second protruding portion 192i are movable in the Y1-Y2 direction within the support hole 116a of the corresponding link support portion 116.

In the present embodiment, when the slider 110 is pushed through the sheet 120 in the Z2 direction as indicated by the dashed arrow A, the slider 110 moves in the Z2 direction. Accordingly, the link mechanism portion 190 is rotated such that the first link portion 191 and the second link portion 192 are opened, and the connection hole portion 191d of the first link portion 191, the connection protruding portion 192d of the second link portion 192, the connection hole portion 191e of the first link portion 191, and the connection protruding portion 192e of the second link portion 192 are moved in the direction indicated by the broken line arrow B, i.e., in the Z1 direction, in the support hole 177b of the link support portion 177.

Accordingly, the first protruding portions 191f and 191g of the first link portion 191 move in the direction indicated by the dashed line arrow C, i.e., in the Y2 direction, inside the support hole 177b of the link support portion 177. In addition, the first protruding portions 192f and 192g of the second link portion 192 move in the direction indicated by dashed arrow D, i.e. in the Y1 direction, inside the support hole 177b of the link support portion 177. The second protruding portions 191h and 191i of the first link portion 191 move in the direction indicated by the dashed line arrow E, i.e., in the Y1 direction, inside the support hole 116a of the link support portion 116. The second protruding portions 192h and 192i of the second link portion 192 move in the direction indicated by the dashed line arrow F, i.e. in the Y2 direction, inside the support hole 116a of the link support portion 116.

Accordingly, the slider 110 is caused to move in the Z2 direction. In the present embodiment, the second protruding portion 191h, the second protruding portion 191i, the second protruding portion 192h, and the second protruding portion 192i of the link mechanism portion 190 are supported in the link support portion 116 provided in the four corners of the slider 110. Thus, even by pushing a corner of the upper surface of the slider 110, the entire slider 110 moves in the Z2 direction, thereby preventing partial pushing.

According to an aspect of the present invention, a push switch that does not change in the operational feeling can be provided.

Although the embodiments have been described in detail, the present invention is not limited to specific embodiments, and various modifications and changes can be made within the scope set forth in the appended claims.

What is claimed is:

1. A push switch comprising:
a housing;
a fixed contact member including a fixed contact, the fixed contact member being placed inside the housing;
a movable contact member including a movable portion, the movable contact member being placed inside the housing;
a slider that moves in a vertical direction with respect to the housing, the slider being placed above the fixed contact member and the movable contact member; and
an elastic member having a restoring force in a direction in which the slider separates from the housing, the elastic member being placed between the housing and the slider, wherein
a movable member is placed between the housing and the slider, the movable member being in contact with a part of the slider, the movable member being movable as the slider moves, and
as the slider is pushed toward the housing, the movable member that is in contact with the slider moves, whereby the fixed contact and the movable portion are separated from each other from a state of being in contact with each other, or the fixed contact and the movable portion are brought into contact with each other from a state of being separated from each other.

2. The push switch according to claim 1, wherein
the slider is provided with a first cam portion;
the movable member is provided with a second cam portion;
as the slider is pushed toward the housing, the first cam portion of the slider moves with respect to the second cam portion of the movable member, whereby the movable member moves.

3. The push switch according to claim 2, wherein
the movable member includes a cylinder portion formed in a cylindrical shape,
the second cam portion is provided on an outside of the cylinder portion, and
as the slider is pushed toward the housing, the movable member rotates on an axis corresponding to a direction in which the slider is pushed.

4. The push switch according to claim 3, wherein
a protruding portion is provided on an outside of the cylinder portion,
in a state where the slider is not pushed, the movable portion of the movable contact member is pushed by the protruding portion such that the movable portion is separated from the fixed contact of the fixed contact member, and
as the slider is pushed toward the housing, the movable member moves in a direction in which the protruding portion moves away from the fixed contact, whereby the fixed contact and the movable portion contact each other due to an elasticity of the movable contact member.

5. The push switch according to claim 2, wherein
the movable member is provided with a third cam portion, and
as the slider is pushed toward the housing, the third cam portion contacts the first cam portion of the slider, whereby the movable member moves.

6. The push switch according to claim 2, wherein
two of the first cam portions are provided, and
two of the second cam portions, corresponding to the respective first cam portions, are provided.

7. The push switch according to claim 1, wherein the slider is formed of a transparent or translucent material.

8. The push switch according to claim 1, wherein the slider and the movable member are both formed of a resin material.

9. The push switch according to claim 1, wherein the housing is formed such that a light emitting element can be placed inside the housing.

10. The push switch according to claim 1, wherein
the slider is provided with a guide portion shaped as a column, the guide portion being provided on a side of the slider facing the housing,
the housing is provided with an opening portion in which the guide portion enters, and
the guide portion is inserted through the opening portion, whereby the slider is supported so as to be movable in the vertical direction with respect to the housing.

11. The push switch according to claim 1, wherein
a link mechanism portion is provided between the slider and the housing, and
the link mechanism includes a pantograph mechanism, whereby the slider is supported so as to be movable in the vertical direction with respect to the housing.
